(19) United States
(12) Patent Application Publication
(10) Pub. No.: US 2026/0233417 A1
(43) Pub. Date: Aug. 13, 2026

(54) FINGER DEVICE OF ROBOT ARM

(71) Applicant: TESOLLO INC., Incheon (KR)

(72) Inventors: Woo Seok RYU, Seoul (KR); Young Jin KIM, Ansan-si, Gyeonggi-do (KR)

(73) Assignee: TESOLLO INC., Incheon (KR)

(21) Appl. No.: 19/154,194

(22) PCT Filed: Feb. 22, 2024
(86) PCT No.: PCT/KR2024/002292

§ 371 Date: Aug. 6, 2025

(30) Foreign Application Priority Data
Mar. 16, 2023 (KR) 10-2023-0034302

(51) Int. Cl. B25J 15/06; B25J 15/00; B25J 15/10

(52) U.S. Cl. CPC B25J 15/0625; B25J 15/0009; B25J 15/103

(57) ABSTRACT

A finger device of a robot arm, includes: a base fixed to the tip of the robot arm; at least two multi-joint frames provided on the base and equipped with actuators that respectively provide power to joints; finger caps that are installed at the ends of the multi-joint frames and come into contact with the surface of an object; suction holes formed in regions of the finger caps that come into contact with the surface of the object; and a negative pressure-generating unit that is connected to the suction holes via flow paths and generates negative pressure in the suction holes.

### CROSS-REFERENCE TO PRIOR APPLICATIONS

This application is a National Stage Patent Application of PCT International Application No. PCT/KR2024/002292 (filed on Feb. 22, 2024, which claims priority to Korean Patent Application No. 10-2023-0034302 (filed on Mar. 16, 2023), which are all hereby incorporated by reference in their entirety.

### BACKGROUND

The present invention relates to a finger device of a robot arm, and more specifically, to a finger device of a robot arm in which suction holes are formed at fingertips that come into contact with an object, thereby enabling the object to be firmly grasped by negative pressure generated at the suction holes.

In general, a robot arm is used for the purpose of automating the transfer and production of products in industrial sites such as manufacturing lines and logistics of semiconductors, food, automobiles, and ships.

The robot arm, which is widely used as described above, typically includes a finger device provided at the tip thereof to grip an object. To imitate the structure of a human hand, the device provided on the robot arm includes actuators installed at joints connecting finger frames so that the finger frames rotate around the joints to grip an object. The finger device will be described with reference to FIG. 1.

FIG. 1 is a perspective view illustrating a finger device according to a conventional art. Referring to the drawing, the finger device according to the conventional art includes a plurality of finger frames 20 installed on a base 10 provided at the tip of a robot arm. The finger frames rotate at a predetermined angle by actuators 30 depending on the shape and position of an object so that fingertips 40 provided at the tips of the finger frames 20 assume a posture suitable for gripping the object.

When the fingertips 40 provided at the tips of the finger frames 20 assume the posture suitable for gripping the object, the fingertips 40 come into contact with the object to grip the object and transport the object to a desired location.

At this time, the fingertips 40 of the finger device, which come into direct contact with the object, are formed in a flat plate shape to grip the object. However, since the fingertips 40 of the finger device are formed in the flat plate shape, it becomes difficult for the fingertips to grip and transport the object when the surface of the object is slippery or when at least two fingertips 40 of the finger device cannot engage the object.

### SUMMARY

The present disclosure has been made to solve the above-mentioned problems occurring in the prior art, and it is an objective to provide a finger device of a robot arm in which suction holes are formed at fingertips that come into contact with an object, thereby enabling the object to be firmly grasped by negative pressure generated at the suction holes.

It is another objective to provide a finger device of a robot arm capable of reducing unnecessary energy consumption by controlling the operation of suction holes according to the gripping state of the object.

To accomplish the above-mentioned objects, according to the present invention, there is provided a finger device of a robot arm including: a base fixed to a tip of the robot arm; at least two multi-joint frames provided on the base and each having an actuator that provides power to each joint; finger caps installed at ends of the multi-joint frames and coming into contact with the surface of an object; suction holes formed in portions of the finger caps that contact the surface of the object; and a negative pressure-generating unit connected to the suction holes via flow paths and generating negative pressure in the suction holes.

Here, the finger caps are made of a material having elastic recovery properties.

Moreover, each finger cap includes a finger holder fixed to an end of the corresponding multi-joint frame inside the finger cap, and the flow path is introduced into the finger holder and guided to the suction hole of the finger cap.

Furthermore, the finger holder is made of a metallic material.

Additionally, each suction hole forms an inclined surface with a diameter that increases from the inside to the outside of the finger cap.

In addition, the negative pressure-generating unit includes: a vacuum pump generating negative pressure; a valve module connected to the vacuum pump, branched to correspond to the suction holes formed in the finger caps, and including a solenoid valve at each branch; and a valve controller configured to independently control the operation of the solenoid valves based on a distance between the object and the finger caps.

Furthermore, the negative pressure-generating unit preferably includes: a vision sensor configured to capture the object and the finger caps respectively provided on the plurality of multi-joint frames arranged on the base, thereby acquiring position information of the object and the finger caps; and a motion controller configured to control the operation of the robot arm and the actuators of the multi-joint frames based on the position information. When the distance between the object and the finger cap becomes within the range of 10 to 30 mm, it is preferable that the valve controller operates to open the corresponding solenoid valve.

In addition, the negative pressure-generating unit preferably further includes a distance sensor provided on the finger cap, the distance sensor being configured to measure the distance between the object and the finger cap and to provide the measured distance to the valve controller.

According to the finger device of a robot arm of the present invention, the multi-joint frames which are provided on the base can adsorb the object through the suction holes formed in the finger caps in the state of assuming the posture suitable for gripping the object and the remaining multi-joint frames operate to stably grip the object, thereby stably gripping and transporting objects of various shapes even in irregular working environments.

Additionally, in the present invention, negative pressure is generated only at the suction holes of the finger caps provided on the specific multi-joint frames gripping the object, while no negative pressure is generated at the suction holes of the finger caps not gripping the object, thus reducing energy consumption and preventing foreign substances in the atmosphere from entering the suction holes.

### BRIEF DESCRIPTION OF THE DRAWINGS

FIG. 1 is a perspective view illustrating a finger device according to a conventional art.

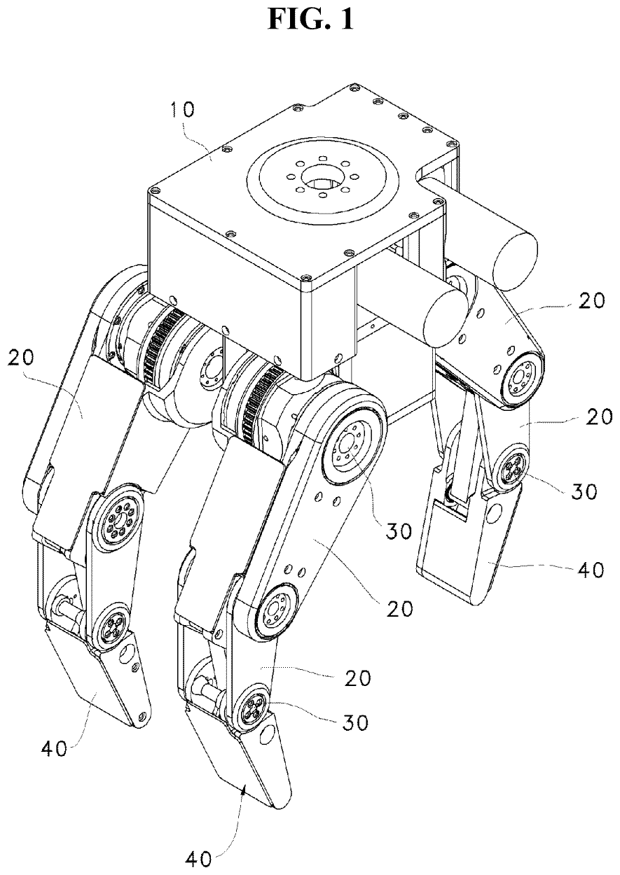

FIG. 2 is a perspective view illustrating a finger device of a robot arm according to the present invention.

FIG. 3 is a front view illustrating the finger device of the robot arm according to the present invention.

FIG. 4 is an exploded perspective view illustrating the finger device of the robot arm according to the present invention.

FIG. 5 is a side cross-sectional view illustrating the finger device of the robot arm according to the present invention.

FIG. 6 is a conceptual diagram illustrating the configuration of a negative pressure-generating unit in the finger device of the robot arm according to the present invention.

FIGS. 7 and 8 are diagrams illustrating operations of the finger device of the robot arm according to the present invention.

### DETAILED DESCRIPTION

The terms and words used in the specification and claims should not be construed as conventional or literal meanings, but should be construed as meanings and concepts corresponding to the technical idea of the present invention based on the principle in which the inventor can suitably define the concept of a term to explain his own invention by the most preferable method.

Hereinafter, preferred embodiments of the present invention will be described in detail with reference to the accompanying drawings.

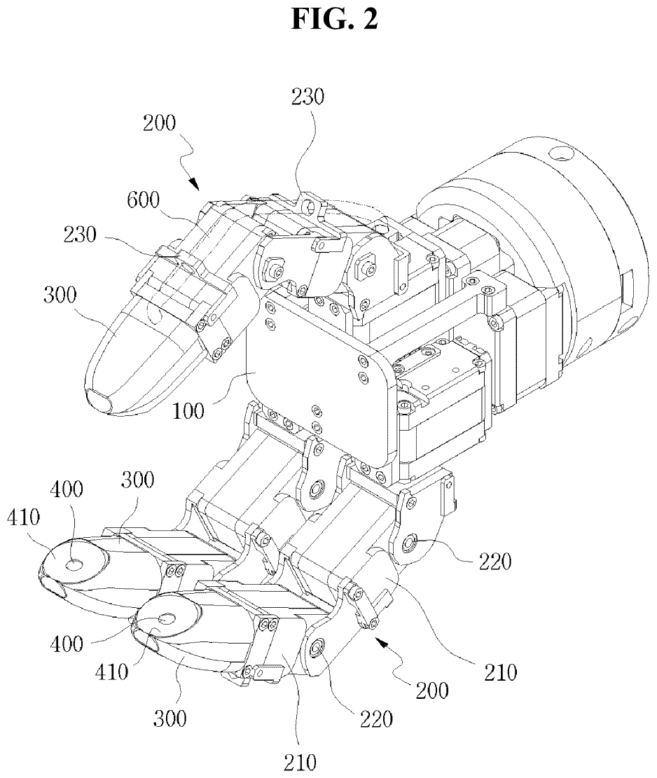

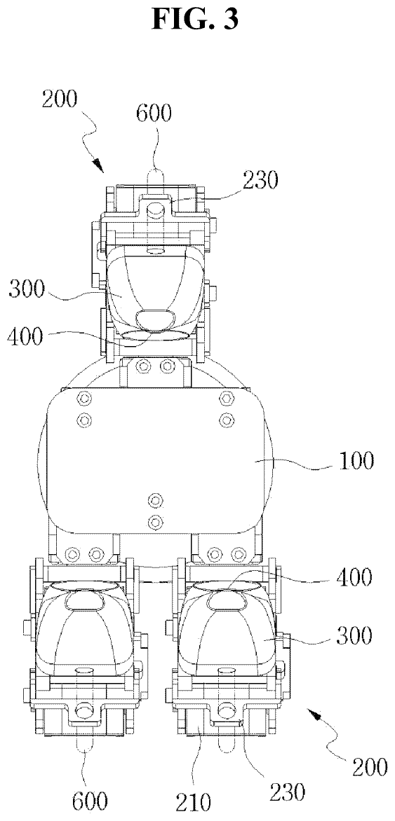

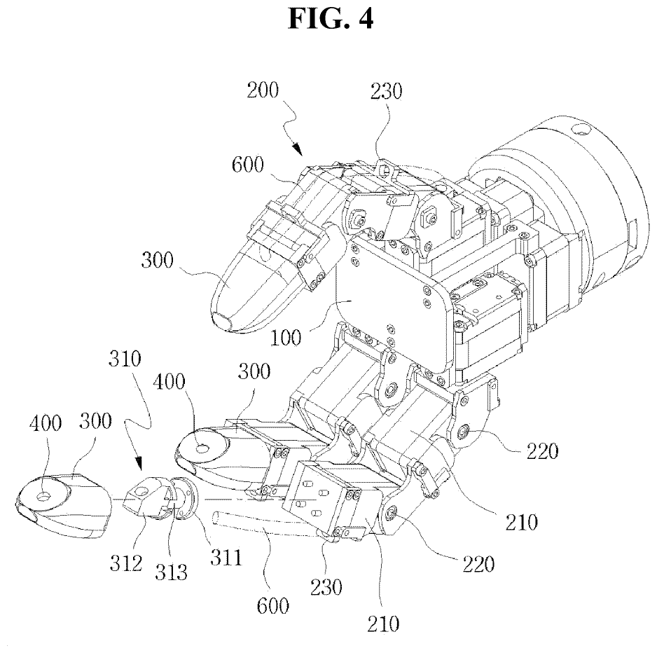

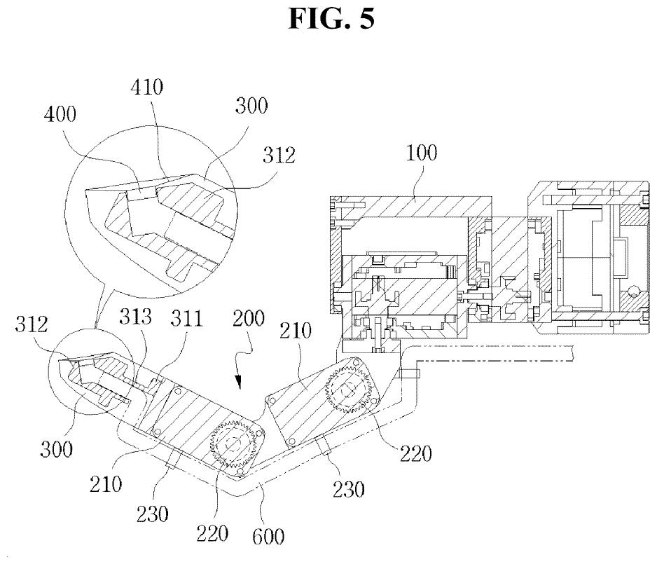

FIG. 2 is a perspective view illustrating a finger device of a robot arm according to the present invention, FIG. 3 is a front view illustrating the finger device of the robot arm according to the present invention, FIG. 4 is an exploded perspective view illustrating the finger device of the robot arm according to the present invention, and FIG. 5 is a side cross-sectional view illustrating the finger device of the robot arm according to the present invention.

Referring to the drawings, the finger device of the robot arm according to the present invention includes a base 100 fixed to the tip of the robot arm; multi-joint frames 200 provided on the base 100; finger caps 300 installed at ends of the multi-joint frames 200; suction holes 400 formed in the finger caps 300; and a negative pressure-generating unit 500 that provides negative pressure to the suction holes 400 so that an object is adsorbed to the finger caps 300.

In more detail, the base 100 is installed at the tip of the robot arm and is connected to the robot arm via a stepping motor (not illustrated) such that the base 100 can rotate at the tip of the robot arm.

At least two multi-joint frames 200 are installed on the base 100. Each multi-joint frame 200 includes a plurality of finger frames 210 sequentially connected to one another, and an actuator 220 such as an output gear installed at each joint connecting the finger frames 210 to provide rotational force to the joint. Accordingly, the finger frames 210 rotate at a predetermined angle around the output gear to assume a posture suitable for gripping an object.

Moreover, the finger cap 300 is installed at the end of each multi-joint frame 200 and comes into contact with the surface of the object. In this instance, the finger cap 300 is made of a such as urethane, silicone, or rubber with a high material coefficient of friction and excellent elastic recovery. So, when the multi-joint frame 200 operates to grip the object, a portion of the finger cap 300 facing the surface of the object is elastically deformed to grip the object.

In particular, the suction hole 400 is formed in the region of the finger cap 300 that is in contact with the surface of the object. When the finger cap 300 comes into contact with the surface of the object, the suction hole 400 sucks air, causing the finger cap to be adsorbed to the surface of the object.

The suction hole 400 formed in the finger cap 300 is connected to the negative pressure-generating unit 500 via a flow path, and forms negative pressure that sucks air from outside the finger cap 300 when the negative pressure-generating unit 500 operates.

The finger cap 300 is installed at the end of the multi-joint frame 200 via a finger holder 310. As illustrated in FIG. 4, the finger holder 310 is fixed to the end of the finger frame 210 constituting the multi-joint frame 200, and the finger cap 300 is formed to surround the finger holder 310.

At this time, the finger holder 310 has a wedge shape such that the finger cap 300 is fixed by being inserted onto the finger holder 310.

To this end, the finger holder 310 includes: a fixing part 311 having a disk shape and fixed to the end of the multi-joint frame 200; an insertion part 312 inserted into the interior of the finger cap 300; and a neck part 313 having a narrowed structure and connecting the insertion part 312 and the fixing part 311. The finger cap 300 surrounds the outer surfaces of the insertion part 312, the fixing part 311, and the neck part 313.

At this time, a portion of the finger cap 300 is positioned and retained in the neck part 313 between the insertion part 312 and the fixing part 311 to prevent the finger cap 300 from unintentionally separating from the finger holder 310.

Furthermore, the finger holder 310 is connected to a tube 600 that forms the flow path to guide the negative pressure provided from the negative pressure-generating unit 500. For this purpose, the flow path is formed inside the finger holder 310 to communicate with the suction hole 400 of the finger cap 300.

The finger holder 310 is made of a rigid material, unlike the finger cap 300. For example, the finger holder 310 is made of a light and rigid material such as aluminum, so that the tube 600 drawn from the negative pressure-generating unit 500 is firmly fixed. The finger holder 310 also supports the finger cap 300 so that it does not deform excessively when the finger cap 300 comes into contact with the object and is elastically deformed.

Additionally, the tube 600 connecting the internal flow path formed in the finger holder 310 to the negative pressure-generating unit 500 is to the outside of the multi-joint frame 200 and the front end of the tube 600 is introduced into the interior of the finger cap 300 to be connected to the finger holder 310.

When the tube 600 connecting the negative pressure-generating unit 500 to the finger holder 310 is positioned outside the multi-joint frame 200, brackets 230 are formed at regular intervals on the multi-joint frame 200 to support the tube 600.

Each bracket 230 has a plate shape with a through-hole through which the tube 600 passes, and when the multi-joint frame 200 operates, the bracket 230 supports the tube 600 to prevent the tube 600 from flapping.

As described above, the suction hole 400, which adsorbs the surface of the object by drawing in external air of the finger cap 300 through the negative pressure provided by the negative pressure-generating unit 500, forms an inclined surface 410, as illustrated in the circle of FIG. 5, such that the diameter gradually increases from the inside to the outside of the finger cap 300.

As described above, when the inclined surface 410 of which the diameter gradually increases from the inside to the outside of the suction hole 400, negative pressure which sucks outside air through the suction hole 400 is applied, thereby increasing the suction area when the finger cap 300 is stuck to the object and reducing noise generated during the air suction. When the finger cap 300 is stuck to the surface of the object, uniform elastic deformation can occur in the finger cap 300, and the finger cap 300 can tightly adhere to the surface of the object.

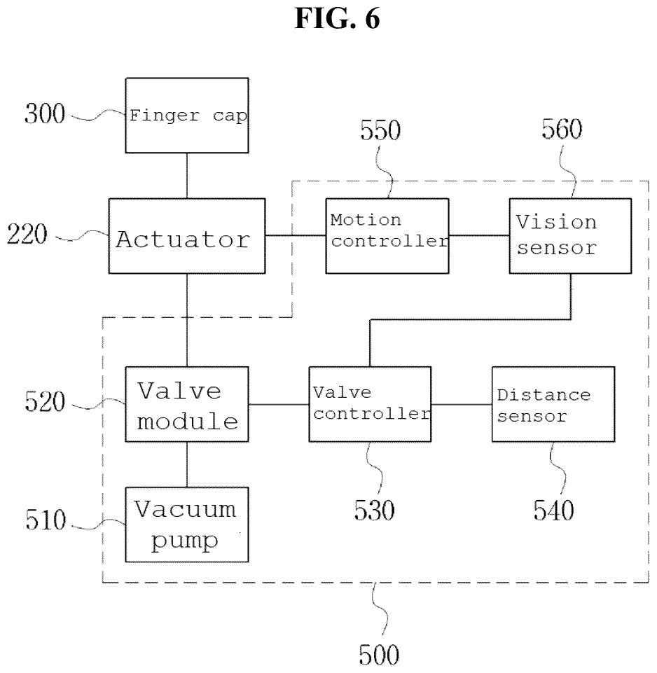

Meanwhile, as illustrated in FIG. 6, the negative pressure-generating unit 500 includes: a vacuum pump 510 that generates negative pressure; a valve module 520 that is connected to the vacuum pump 510, branched to correspond to the suction holes 400 formed in the finger caps 300, and provided with a solenoid valve at each branch; and a valve controller 530 that controls the operation of each solenoid valve according to the distance between the object and the finger cap 300.

Moreover, the vacuum pump 510 operates by vibrating a thin diaphragm to alternately expand and contract the volume of an enclosed space, thereby drawing in or expelling air and forming pressure lower than atmospheric pressure. The vacuum pump 510 may be installed on the robot arm or on the base 100 fixed at the tip of the robot arm.

Furthermore, the vacuum pump 510 is connected to the valve module 520. The valve module 520 is branched to correspond to the suction holes 400 formed in the finger caps 300, and the solenoid valves are installed at each branch. According to the operation of each solenoid valve, the respective flow paths are opened or closed, thereby controlling the negative pressure supplied to each suction hole 400.

The solenoid valves of the valve module 520 are electrically connected to the valve controller 530. The valve controller 530 controls the operation of each solenoid valve based on the distance between the object and the finger cap 300.

For example, when the distance between the object and the finger cap 300 is within 10 to 30 mm, the valve controller 530 opens the corresponding solenoid valve to form negative pressure in the suction hole 400 of the finger cap 300. When the distance exceeds 10 to 30 mm, the corresponding solenoid valve is closed so that no negative pressure is formed in the suction hole 400.

Accordingly, negative pressure is formed only in the suction holes 400 of the finger caps 300 provided on the multi-joint frames 200 that are gripping the object, while no negative pressure is formed in the suction holes 400 of the finger caps 300 that are not gripping the object, thereby reducing energy consumption and preventing foreign substances in the atmosphere from entering the suction holes 400.

In addition, the negative pressure-generating unit 500 includes a motion controller 550 and a vision sensor 560. The vision sensor 560 is installed above the object such that both the object and the robot arm can be simultaneously captured.

The vision sensor 560 captures the object and the plurality of finger caps 300 respectively provided on the multiple multi-joint frames 200 arranged on the base 100, thereby acquiring position information of the object and the finger caps 300.

Moreover, based on the position information obtained from the vision sensor 560, the motion controller 550 controls the operation of the robot arm and the actuators 220 of the multi-joint frames 200. The motion controller 550 is electrically connected to the valve controller 530, and when the distance between the object and a finger cap falls within 10 to 30 mm, the valve controller 530 operates to open the corresponding solenoid valve.

With the vision sensor 560 and the motion controller 550 provided in the negative pressure-generating unit 500, the motion controller 550 controls the operation of the actuators 220 respectively provided on the multi-joint frames 200 based on the position information of the object and the finger caps 300 obtained through the vision sensor 560 such that each finger cap 300 approaches the object to enable gripping.

As described above, when the finger cap 300 approaches the object and the distance between the finger cap 300 and the object becomes 10 to 30 mm, the valve controller 530 controls the operation of the solenoid valve provided in the valve module 520, thereby allowing air to be drawn in through the suction hole 400 formed in the finger cap 300.

When the finger cap 300 comes into contact with the surface of the object while negative pressure is formed in the suction hole 400, the finger cap 300 adsorbs the object to stably grip and transport the object.

Moreover, when the object in a gripped and adsorbed state is transported to a designated location, the vision sensor 560 detects it and controls the motion controller 550 and the valve controller 530. Accordingly, the finger cap 300 that was gripping the object is moved away from the object, the solenoid valve of the corresponding finger cap 300 is closed to release the negative pressure in the suction hole, and then, the finger device is moved to a new position for transporting the next object.

Meanwhile, the valve controller 530, which controls the operation of the solenoid valves provided in the valve module 520 based on the distance between the object and the finger cap 300, is electrically connected to a distance sensor 540. The distance sensor 540 is installed on the finger frame 210 to which the finger cap 300 or the finger holder 310 is mounted.

The distance sensor 540 may be, for example, an ultrasonic sensor using sound waves, an infrared sensor using infrared rays, a LiDAR sensor using lasers, or a radar sensor using radio waves. The distance sensor 540 measures the distance to the object and provides the measured distance to the valve controller 530.

The valve controller 530 which receives the distance to the object through the distance sensor 540 is electrically connected to the solenoid valve provided in the valve module 520 to control the operation of the solenoid valve corresponding to the finger cap 300 where the distance was measured, thereby controlling the negative pressure of the suction hole 400 formed in the finger cap 300.

In the finger device of the robot arm according to the present invention having the above configuration, after each multi-joint frame 200 provided on the base 100 assumes a posture suitable for gripping the object, the object is adsorbed through the suction hole 400 formed in the finger cap 300, and then the remaining multi-joint frames 200 operate to grip the object, thereby stably gripping the object.

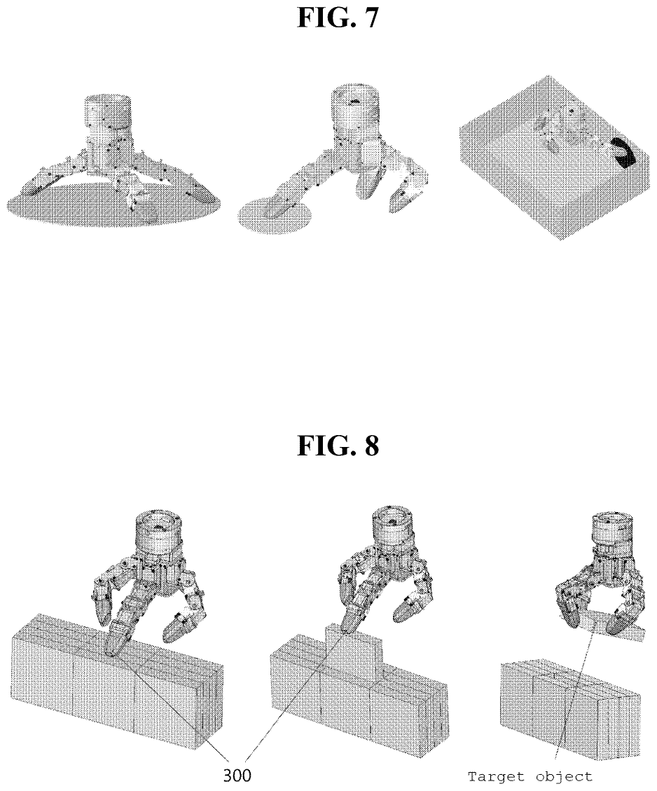

That is, as illustrated in FIGS. 7 and 8, in order to transport a thin object or any one object selected from among a plurality of aligned objects, the finger device of the present invention allows one of the multi-joint frames 200 to approach the object, adsorbs the object through the suction hole 400 of the finger cap 300, and then operates the remaining multi-joint frames 200 to grip the object. As a result, the object can be reliably gripped and transported even in irregular working environments.

Meanwhile, the present invention is not limited to the embodiments described above, but may be modified and altered without departing from the spirit of the present invention. Any such modifications and alterations shall also fall within the scope of the technical idea of the present invention.

*Description of reference numerals*

| | |
|---|---|
| 100: Base | 20: Multi-joint frame |
| 210: Finger frame | 220: Actuator |
| 230: Bracket | 300: Finger cap |
| 310: Finger holder | 311: Fixing part |
| 312: Insertion part | 313: Neck part |
| 400: Suction hole | 410: Inclined surface |
| 500: Negative pressure-generating unit | 510: Vacuum pump |
| 520: Valve module | 530: Valve controller |
| 540: Distance sensor | 550: Motion controller |
| 560: Vision sensor | 600: Tube |

1. A finger device of a robot arm comprising:
a base fixed to a tip of the robot arm;
at least two multi-joint frames provided on the base and each having an actuator that provides power to each joint;
finger caps installed at ends of the multi-joint frames and coming into contact with the surface of an object;
suction holes formed in portions of the finger caps that contact the surface of the object; and
a negative pressure-generating unit connected to the suction holes via flow paths and generating negative pressure in the suction holes.

2. The finger device of claim 1, wherein the finger caps are made of a material having elastic recovery properties.

3. The finger device of claim 1, wherein each finger cap includes a finger holder fixed to an end of the corresponding multi-joint frame inside the finger cap, and the flow path is introduced into the finger holder and guided to the suction hole of the finger cap.

4. The finger device of claim 3, wherein the finger holder is made of a metallic material.

5. The finger device of claim 1, wherein each suction hole forms an inclined surface with a diameter that increases from the inside to the outside of the finger cap.

6. The finger device of claim 1, wherein the negative pressure-generating unit comprises:
a vacuum pump generating negative pressure;
a valve module connected to the vacuum pump, branched to correspond to the suction holes formed in the finger caps, and including a solenoid valve at each branch; and
a valve controller configured to independently control the operation of the solenoid valves based on a distance between the object and the finger caps.
